(19) United States
(12) Patent Application Publication
(10) Pub. No.: US 2014/0108367 A1
(43) Pub. Date: Apr. 17, 2014

(54) CLIENT APPARATUS AND DATABASE SERVER FOR RESUMABLE TRANSACTION AND METHOD THEREOF

(71) Applicant: TIBERO CO., LTD., Gyeonggi-do (KR)

(72) Inventors: Cheolwoo Kim, Gyeonggi-do (KR); Sang Young Park, Gyeonggi-do (KR); Chang Ho Hwang, Gyeonggi-do (KR)

(73) Assignee: TIBERO CO., LTD., Gyeonggi-do (KR)

(21) Appl. No.: 13/664,739

(22) Filed: Oct. 31, 2012

(30) Foreign Application Priority Data
Oct. 12, 2012 (KR) 10-2012-0113773

(51) Int. Cl. G06F 17/30

(52) U.S. Cl. 707/703; 707/E17.001

(57) ABSTRACT

A transaction resuming method includes receiving a transaction unit divided into subsets by the unit when performing a transaction with a client, performing a rollback in a reverse order of the transaction when there is an error, and generating a resumable point to resume the transaction. The method further includes providing the resumable point to the client and receiving transaction unit after the resumable point to resume the transaction.

### FIELD OF THE INVENTION

The present invention relates to a transaction processing in a database environment, and more particularly, to a client apparatus and a database server for a resumable transaction and method thereof, capable of dividing a transaction into recoverable subsets by the unit when performing the transaction in a single server and clustering database environment and transmitting them, and when executing a rollback due to a server problem, performing in a reverse order of the transaction unit a rollback for the transaction unit received and stopping the rollback at a point when the transaction is detected, the point being when a consistency is guaranteed, and preserving transaction information until the resumable point, thereby resuming the transaction after the resumable point without resuming the transaction from the beginning and increasing data transmission efficiency.

Support for the present invention was provided by Ministry of Knowledge Economy in Korea under Project 10040937 [Source Technology Development Business for Industrial Convergence].

### BACKGROUND OF THE INVENTION

Generally, a Database Management System (referred to as DBMS, hereinafter) indicates a system to manage a database in which a massive amount of data is stored.

In such a DBMS, all data is stored in the database in a format of a table where the table indicates to a basic structure with which data is stored in the database and a table is comprised of one or more records.

Further, each record is comprised of one or more columns where the column indicates a domain having a name expressing a table item in a real-world, which is also referred to as attribute or field.

When a specific query is input to the DBMS, the DBMS performs functions of selecting, inserting, updating and deleting data in the database according to the input query. Here, the query indicates a specific request for the data stored in the table of database, that is, the query shows an operation required for the data. The query is expressed using a language such as SQL (Structured Query Language).

Meanwhile, a transaction is performed in the DBMS when DML operations of inserting, deleting and updating data are processed where such transactions indicate a continuous unit for a series of works such as information exchange or database update and a basic unit for work to complete works requested in a state where integrity is guaranteed.

However, in case that there is a problem in a database server when the transaction is performed between a client and the database server, since it is not possible to provide fail-over for transaction contents in a conventional art, data of transaction that was not completed is lost, the transaction should be performed from the beginning when a rollback is performed from the database.

### SUMMARY OF THE INVENTION

It is, therefore, an object of the present invention to provide a client apparatus and a database server for a resumable transaction and method thereof, capable of dividing a transaction into recoverable subsets by the unit when performing the transaction in a single server and clustering database environment and transmitting them, and when executing a rollback due to a server problem, performing in a reverse order of the transaction unit a rollback for the transaction unit received and stopping the rollback at a point when the transaction is detected, the point being when a consistency is guaranteed, and preserving transaction information until the resumable point, thereby resuming the transaction after the resumable point without resuming the transaction from the beginning and increasing data transmission efficiency.

In accordance with an aspect of the present invention, there is provided a client apparatus for a resumable transaction, including: a communication unit for connecting the client apparatus to a database server and performing data communication according to a transaction performance; a unit constructing part for constructing a transaction unit that is made by dividing transaction data to be transmitted to the server according to the transaction performance into subsets by the unit; and a control unit for controlling the transaction unit so as to be transmitted to the server, and controlling the transaction unit provided after a resumable point in which consistency is guaranteed to resume the transaction, the resumable point being provided from the server, in case that a rollback occurs while the transaction is performed.

The unit constructing part divides the transaction into subsets based on SQL statement unit or batch buffer and constructs the transaction unit.

The unit constructing part gives the subsets sequence numbers.

The transaction is constructed in a SQL format or batch format.

The client apparatus further includes a caching unit for storing the transaction unit transmitted to the server.

The control unit sequentially reads out the transaction unit provided after the resumable point from the cashing unit and transmits the transaction unit again, when the transaction is resumed.

In accordance with another aspect of the present invention, there is provided a database server for resumable transaction, including: a communication unit for connecting the database server to a client apparatus and performing data communication according to a transaction performance; a data processing unit for receiving a transaction unit transmitted from the client apparatus that is divided into subsets by the unit according to the transaction performance and processing transaction information by the unit; a recovery unit for performing a rollback for the transaction in a reverse order of the transaction unit by the unit when a rollback occurs while the transaction is performed and simultaneously generating a resumable point to resume the transaction; and a control unit for executing a rollback for the transaction through the recovery unit in case that it is not possible to perform the transaction, providing the resumable point when the client apparatus is connected again, and receiving the transaction unit provided after the resumable point, thereby resuming the transaction.

The recovery unit searches for the transaction unit whose consistency is guaranteed while performing the rollback, and generates a searching point of the transaction unit whose consistency is guaranteed as a resumable point to resume the transaction.

The recovery unit performs the rollback until the point when the transaction unit whose consistency is guaranteed is searched for.

The recovery unit preserves the transaction unit provided before the resumable point.

The data processing unit stores identification information used to identify each transaction unit together with the transaction unit.

The identification information is set to identify a consistency of the transaction unit.

In accordance with another aspect of the present invention, there is provided a method for resumable transaction, including: dividing transaction data to be transmitted to a database server when performing a transaction with the database server into subsets by the unit and constructing the subsets as a transaction unit; transmitting the transaction unit to the server according to the transaction performance; receiving a resumable point in which a consistency to resume the transaction is guaranteed from the server, in case that a rollback occurs while the transaction is performed; and transmitting a transaction resuming request to the server so that the transaction is resumed after the resumable point when connected to the server.

The transaction unit is divided into subsets based on SQL statement unit or batch buffer.

The subset is assigned each sequence number.

The transmitting the transaction resuming request includes: detecting the transaction unit provided after the resumable point from a caching unit to store the transaction unit transmitted to the server; and reading out the detected transaction units sequentially and transmitting the transaction units again.

In accordance with another aspect of the present invention, there is provided a transaction resuming method, including: performing a transaction with a client; receiving a transaction unit divided into subsets by the unit when performing the transaction and processing transaction information by the unit; performing a rollback for the transaction in a reverse order of the transaction unit when the rollback occurs while performing the transaction; generating a resumable point to resume the transaction while performing the rollback; providing the resumable point when connected to the client again; and receiving the transaction unit provided after the resumable point and resuming the transaction.

The generating the resumable point includes: searching for the transaction unit in which a consistency is guaranteed while performing the rollback; and generating a searching point of the transaction unit in which consistency is guaranteed as the resumable point to resume the transaction.

The method further includes preserving the transaction unit provided before the resumable point, after generating the resumable point.

The present invention has an advantage that is capable of dividing a transaction into recoverable subsets by the unit when performing the transaction in a single server and clustering database environment and transmitting them, and when executing a rollback due to a server problem, performing in a reverse order of the transaction unit a rollback for the transaction unit received and stopping the rollback at a point when the transaction is detected, the point being when a consistency is guaranteed, and preserving transaction information until the resumable point, thereby resuming the transaction after the resumable point without resuming the transaction from the beginning and increasing data transmission efficiency.

### BRIEF DESCRIPTION OF THE DRAWINGS

The above and other objects and features of the present invention will become apparent from the following description of embodiments given in conjunction with the accompanying drawings, in which:

FIG. 1 is a block diagram of a client and server network for a resumable transaction according to an embodiment of the present invention;

FIG. 2 is an operational control flow diagram of a client apparatus for a resumable transaction according to an embodiment of the present invention; and

FIG. 3 is an operational control flow diagram of a server for a resumable transaction according to an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art. Further, terms below are defined in consideration of functions in the present invention, which can be changed according to intensions of users and operators or precedents. The definitions of these terms therefore should be determined based on the contents throughout the specification.

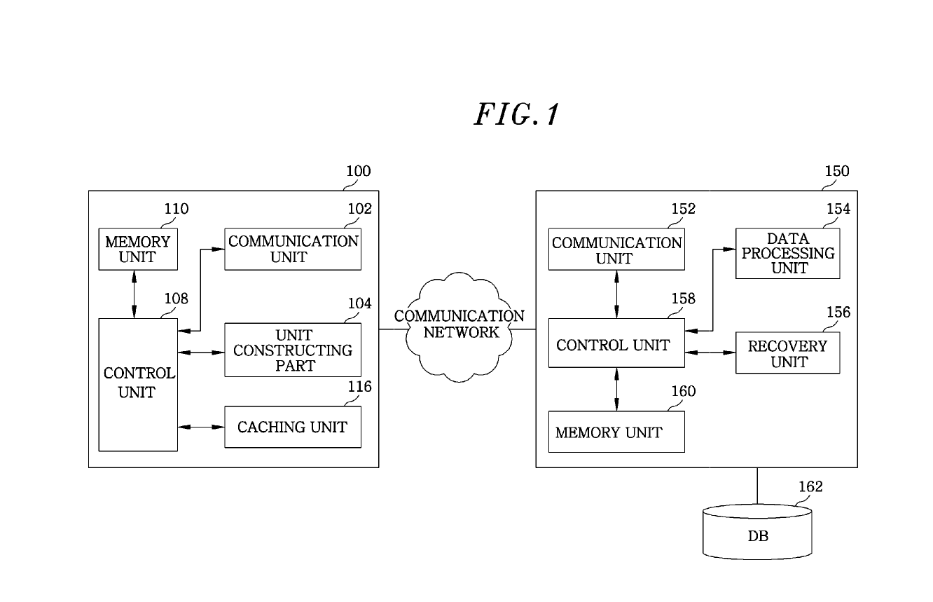

FIG. 1 is a network construction of a client apparatus 100 and database server 150 for a resumable transaction according to an embodiment of the present invention.

Hereinafter, a resumable operation of a transaction in a single server and clustering database environment according to an embodiment of the present invention will be described with reference to FIG. 1.

First, the client apparatus 100 refers to a user terminal apparatus that can be connected to the database server 150 through a communication network, and search for and change data, which can perform a transaction of inserting, deleting or updating data in a database 162 when it is connected to the database server 150.

In a such a transaction, at this time, in case that a problem occurs in the database server 150 when a transaction is performed between the client apparatus 100 and the database server 150, it was described above that data of the transaction that has not been completed was lost since it is not possible to provide fail-over for transaction contents in the conventional art, and the transaction should be performed from the beginning when a rollback was performed from the database server 150.

In the embodiment of the present invention, accordingly, a transaction is performed in that it is divided into recoverable subsets measured in a unit and transmitted in the client apparatus 100, and the subsets of the transaction transmitted to the database server 150 are cashing and stored, so that resumable point information of a subset whose consistency is proved from the database server 150 when providing a rollback caused by a problem of the database server 150 is received and the transaction is restarted in that the subsets only after the resumable point are retransmitted without performing entire transaction again.

Hereinafter, the above operation of the client apparatus 100 will be described in more detail by describing operation of each element of the client apparatus 100.

A communication portion 102 connects the client apparatus 100 to the database server 150 through a communication network and interfaces data that is communicated according to the transaction between the client apparatus 100 and the database server 150.

A unit constructing portion 104 divides transaction data transmitted from the client apparatus 100 to the database server 150 according to the transaction performance, into subsets measured in a unit. That is, the unit construction portion 104 divides the transaction formed in SQL or batch that is transmitted from the client apparatus 100 to the database server 150, into subsets based on SQL statement unit or batch buffer and gives sequence numbers to them.

As described above, the transaction unit that is divided into the subsets and given the sequence numbers in the unit constructing portion 104 is transmitted to the database server 150 through a communication portion 102 of the client apparatus 100 as the transaction is performed between the client apparatus 100 and the database server 150.

A cashing portion 106 stores in a unit the transaction unit transmitted to the database server 150 according to the transaction performance.

A control portion 108 controls a general operation of the client apparatus 100 according to an operation control program stored in the memory portion 110, and controls each portion for a resumable transaction to the database server 150 according to an embodiment of the present invention.

That is, the control portion 108 causes data transmitted to the database server 150 through the unit constructing portion 104 according to the transaction performance to be transmitted to the transaction unit, and stores the transaction unit transmitted as mentioned above in the cashing portion 106 so that it restarts the transaction from the transaction unit after a resumable point provided from the database server 150, whose consistency is guaranteed without performing the transaction from the beginning when performing a rollback caused by a problem of the database server 150, thereby increasing data transmission efficiency.

Further, the control portion 108 can receive a time point when a reflection is completed consistently and permanently or number of the transaction unit as a response message, and removes a transaction unit whose reflection was completed in the server 150 from the cashing portion 106 using information on the transaction unit so that it is possible to prevent the cashing portion 106 from wasting memory, caused by storing unnecessary information.

Next, the database server 150 inserts, deletes or updates data in the database 162 according to the transaction performance with the client apparatus 100 that is connected through the communication network.

At this time, in case that the database server 150 does not complete the transaction since some problems occur in the database server 150 when the database server 150 performs the transaction with the client apparatus 100, a rollback for the transaction is performed in the art so that the transaction is performed from the beginning. So, even the data according to the transaction performed before the problem occurred is all deleted so that unnecessary load may be occurred in the transaction performance procedure.

In the embodiment of the present invention, accordingly, in case that the data transmitted from the client apparatus 100 according to the transaction performance is composed of recoverable transaction unit, a rollback is not performed for entire transaction when the transaction recovery is performed for the problem of the database server 150. Rather than, when the transaction unit whose consistency is guaranteed is detected while performing the rollback for the transaction unit received in the reverse order by the unit, information until the detected transaction unit is preserved and the transaction is performed again from the transaction unit that was preserved after the problem recovery so that the transaction can be resumed.

Hereinafter, operations of the database server 150 will be described by describing operations of each constituent of the database server 150 in more detail.

The communication unit 152 connects the client apparatus 100 and the database server 150 together and interfaces data that is transmitted and received as the transaction is performed between the client apparatus 100 and the database server 150. Further, as problems occurs in the database server 150, information on rollback command and transaction resumable point occurring in the database server 150 can be transmitted to the client apparatus 100.

As the transaction is performed between the client apparatus 100 and the database server 150, the data processing unit 154 processes recoverable data transmitted from the client apparatus 100 by the unit, that is, the transaction information by transaction unit and stores it. At this time, the data processing unit 154 also stores identification information to identify whether the data was consistently stored by the transaction unit in the database 162.

Meanwhile, in case that the transaction is completed since problems of the database server 150 occurs while performing the transaction, the rollback is performed in the database server 150.

In case that a rollback is performed for the transaction that was not completed, the recovery unit 156 does not perform rollback for the entire transaction but perform rollback in the reverse order of the transaction unit, which is different from the operation in which the transaction is resumed from the beginning in the art.

That is, the recovery unit 156 searches for the transaction unit whose consistency is guaranteed while performing the rollback in the reverse order of the transaction unit. In case that the recovery unit 156 detects the transaction unit whose consistency is guaranteed, it stops the rollback and preserves the information up to the transaction unit, and generates the point when the rollback is stopped as a resumable point. The information on the resumable point generated as such is provided to the client apparatus 100 in case that the client apparatus 100 is connected again after the problem recovery so that the client apparatus 100 can resume the transaction from the resumable point.

The control unit 158 controls the entire operation of the database server 150 according to an operation control program stored in the memory 160, and controls operations of each part to resume the transaction with the client apparatus 100 according to the embodiment of the present invention.

That is, when the control unit 158 performs a transaction recovery due to the problem of the database server 150, it does not perform the rollback for the entire transaction but performs the rollback for the transaction unit received through the recovery unit 156 in the reverse order of the transaction unit. Further, in case of detecting the transaction unit whose consistency is guaranteed, the control unit 158 preserves the information up to the transaction unit and performs the transaction after the transaction that is preserved after the problem was recovered so that the transaction can be resumed.

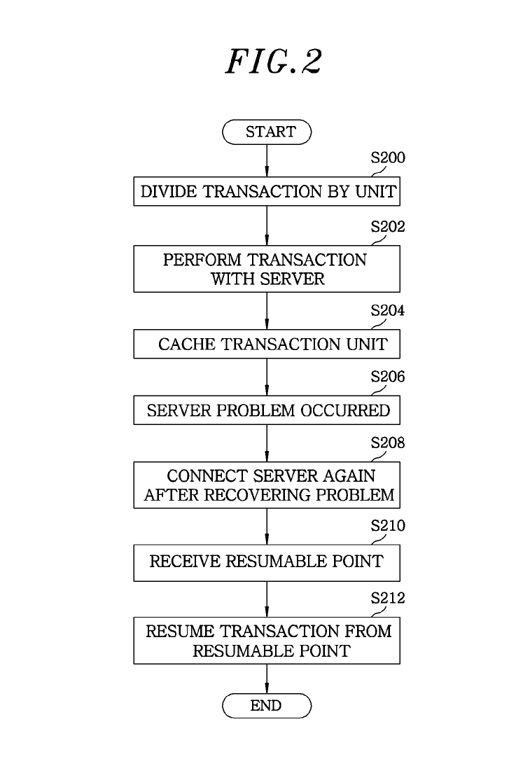

FIG. 2 is an operational control flow diagram of a client apparatus 100 for a resumable transaction according to an embodiment of the present invention, and hereinafter, an embodiment of the present invention will be described in detail with reference to FIGS. 1 and 2.

First, in case that a transaction is performed between a client apparatus 100 and a database server, a control unit 108 of the client apparatus 100 controls a unit constructing part 104 to construct a transaction unit that is made by dividing the transaction data transmitted to the database server 150 into subsets by the unit (S200).

That is, the unit constructing part 104 divides the transaction in a SQL format or batch format that is transmitted from the client apparatus 100 to the database server 150 into subsets based on SQL statement unit or batch buffer, and gives them sequence numbers so that a transaction unit is constructed.

Subsequently, the control unit 108 transmits the transaction unit which was divided into subsets in the unit constructing part 104 and to which the sequence numbers are given, to the database server 150 according to the transaction performance between the client apparatus 100 and the database server 150 (S202).

Further, the control unit 108 stores the transaction unit transmitted according to the transaction performance between the client apparatus 100 and the database server 150 in the caching unit 106 by the unit, preparing for the transaction resuming (S204).

Meanwhile, a case may occur that problems may occur in the database server 150 while a transaction is performed between the client apparatus 100 and the database server 150 so that it is not possible to perform a transaction (S206).

As such, in case that problem occurs in the database server 150, the transaction that was not completed is stopped to perform. Further, after the problem of the database server 150 is recovered, the transaction is again resumed to perform at the point that the client apparatus 100 is connected to the database server 150 again.

According to the preset invention, at this time, the transaction that was not completed in the database server 150 is not resumed from the beginning. Rather, after detecting the resumable point in which consistency is guaranteed by performing a rollback in the reverse order of the transaction unit, the transaction is completed by receiving the transaction unit provided after the resumable point. The database server 150 provides the resumable point detected as such to resume the transaction in case that the client apparatus is connected again.

That is, the control unit 108 of the client apparatus 100 performs a connection again as the problem of the database server 150 is recovered (S208), it receives information on the resumable point to resume the transaction from the database server 150 (S210).

Accordingly, the control unit 108 does not resume the transaction from the beginning when performing the rollback according to the problem of the database server 150, but resumes the transaction unit provided after the resumable point provided from the database server 150 in which consistency is guaranteed so that it is possible to increase data transmission efficiency.

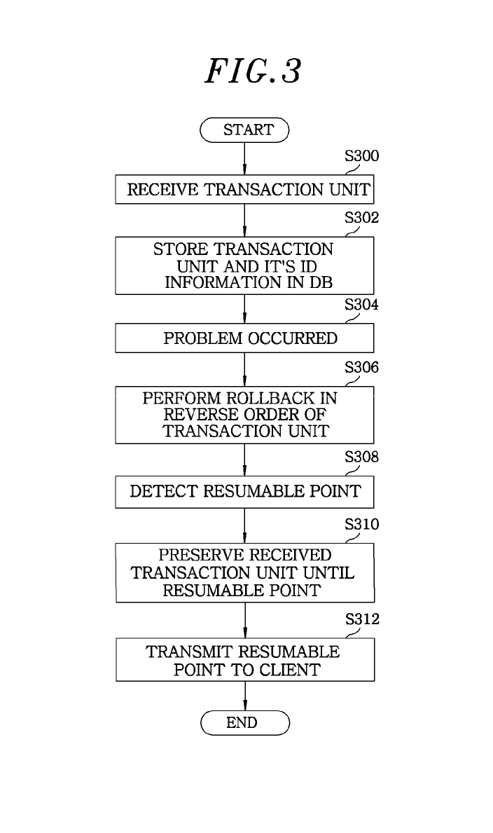

FIG. 3 is an operational control flow diagram of a database server 150 for a resumable transaction according to an embodiment of the present invention.

Hereinafter, an embodiment of the present invention will be described in detail with reference to FIGS. 1 and 3.

First, in case that a transaction is performed with the client apparatus 100, the control unit of the database server 150 receives a transaction unit that is divided by the unit and transmitted, to resume the transaction through the communication unit 152 (S300).

Next, the control unit 158 controls the data processing unit 154 to process transaction information by the transaction unit, and stores it together with identification information to identify whether the information was consistently stored by the transactinon unit (S302).

Meanwhile, a case may occur that the transaction cannot be completed due to the problem of the database server 150 while such transaction is performed, and in this case the control unit 158 performs a rollback so that the transaction that was not completed is performed again (S304).

In such a rollback performance, while the client apparatus 100 resumes the transaction from the beginning in the art, according to the embodiment of the present invention, the rollback for the entire transaction is not performed but the rollback is performed in the reverse order of the transaction unit by controlling the recovery unit 156 (S306).

That is, the recovery unit 156 searches for the transaction unit whose consistency is guaranteed while performing the rollback in the reverse order of the transaction unit according to control of the control unit 158, stops the rollback when detecting the transaction unit whose consistency is guaranteed, and generates this point as a resumable point (S308).

Further, the recovery unit 156 preserves information up to the transaction unit at the point when the rollback generated through the recovery unit 156, the control unit 158 provides the client apparatus 100 with the resumable point when the client apparatus is connected again after the problem of the database server 150 was recovered, and makes the transaction resume in the client apparatus 100 from the resumable point.

As described above, the present invention is capable of dividing a transaction into recoverable subsets by the unit when performing the transaction in a single server and clustering database environment and transmitting them, and when executing a rollback due to a server problem, performing in a reverse order of the transaction unit a rollback for the transaction unit received and stopping the rollback at a point when the transaction is detected, the point being when a consistency is guaranteed, and preserving transaction information until the resumable point, thereby resuming the transaction after the resumable point without resuming the transaction from the beginning and increasing data transmission efficiency.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A client apparatus for a resumable transaction, comprising:
a communication unit connecting the client apparatus to a database server and performing data communication according to a transaction performance;
a unit constructing part for constructing a transaction unit that is made by dividing transaction data to be transmitted to the server according to the transaction performance into subsets by the unit; and
a control unit for controlling the transaction unit so as to he transmitted to the server, and controlling the transaction unit provided after a resumable point in which consistency is guaranteed to resume the transaction, the resumable point being provided from the server, in case that a rollback occurs while the transaction is performed.

2. The client apparatus of claim 1, wherein the unit constructing part divides the transaction into subsets based on SQL statement unit or batch buffer and constructs the transaction unit.

3. The client apparatus of claim 2, wherein the unit constructing part gives the subsets sequence numbers.

4. The client apparatus Of claim wherein the transaction is constructed in a SQL format or batch format.

5. The client apparatus of claim 1, further comprising a caching unit for storing the transaction unit transmitted to the server.

6. The client apparatus of claim 5, wherein the control unit sequentially reads out the transaction unit provided after the resumable point from the cashing unit and transmits the transaction unit again, when the transaction is resumed.

7. A database server for resumable transaction, comprising:
a communication unit for connecting the database
server to a client apparatus and performing data communication according to a transaction performance;
a data processing unit for receiving a transaction
unit transmitted from the client apparatus that is divided into subsets by the unit according the transaction performance and processing transaction information by the unit;
a recovery unit for performing a rollback for the
transaction in a reverse order of the transaction unit by the unit when a rollback occurs while the transaction is performed and simultaneously generating a resumable point to resume the transaction; and
control unit for executing a rollback for the transaction through the recovery unit in case that it is not possible to perform the transaction, providing the resumable point when the client apparatus is connected again, and receiving the transaction unit provided after the resumable point, thereby resuming the transaction.

8. The database server of claim 7, wherein the recovery unit searches for the transaction unit whose consistency is guaranteed while performing the rollback, and generates a searching point of the transaction unit whose consistency is guaranteed as a resumable point to resume the transaction.

9. The database server of claim 8, wherein the recovery unit performs the rollback until the point when the transaction unit whose consistency is guaranteed is searched for.

10. The database server of claim 8, wherein the recovery unit preserves the transaction unit provided before the resumable point.

11. The database server of claim wherein the data processing unit stores identification information used to identify each transaction unit together with the transaction unit.

12. The database server of claim 11, wherein the identification information is set to identify a consistency of the transaction unit.

13. A method for resumable transaction, comprising:
dividing transaction data to be transmitted to a database server when performing a transaction with the database server into subsets by the unit and constructing the subsets as a transaction unit;
transmitting the transaction unit to the server according to the transaction performance;
receiving a resumable point in which a consistency to resume the transaction is guaranteed from the server, in case that a rollback occurs while the transaction is performed; and
transmitting a transaction resuming request to the server so that the transaction is resumed after the resumable point when connected to the server.

14. The method of claim 13, wherein the transaction unit is divided into subsets based on SQL statement unit or batch buffer.

15. The method of claim 14, wherein the subset is assigned each sequence number.

16. The method of claim 13, wherein said transmitting the transaction resuming request includes:
detecting the transaction unit provided after the resumable point from a caching unit to store the transaction unit transmitted to the server; and
reading out the detected transaction units sequentially and transmitting the transaction units again.

17. A transaction resuming method, comprising:
performing a transaction with a client;
receiving a transaction unit divided into subsets by the unit when performing the transaction and processing transaction information by the unit;
performing a rollback for the transaction in a reverse order of the transaction unit when the rollback occurs while performing the transaction;
generating a resumable point to resume the transaction while performing the rollback;
providing the resumable point when connected to the client again; and
receiving the transaction unit provided after the resumable point and resuming the transaction.

18. The method of claim 17, wherein said generating the resumable point includes:
searching for the transaction unit in which a consistency is guaranteed while performing the rollback; and
generating a searching point of the transaction unit in which consistency is guaranteed as the resumable point to resume the transaction.

19. The method of claim 17, further comprising preserving the transaction unit provided before the resumable point, after generating the resumable point.
